(19) United States
(12) Patent Application Publication
(10) Pub. No.: US 2013/0286482 A1
(43) Pub. Date: Oct. 31, 2013

(54) Landing Zone Identification Marker

(71) Applicants: Douglas Andre Racicot, Tolland, CT (US); Glen Edgar Johnson, Tolsand, CT (US)

(72) Inventors: Douglas Andre Racicot, Tolland, CT (US); Glen Edgar Johnson, Tolsand, CT (US)

(21) Appl. No.: 13/457,487

(22) Filed: Apr. 27, 2012

(51) Int. Cl. G02B 5/12

(52) U.S. Cl. 359/553

(57) ABSTRACT

A temporary, moveable marker for directing emergency aircraft to a landing zone employs a set of four panels which are foldable into a compact configuration. These panels are deployed in a substantially rectangular configuration to provide markings for an emergency landing zone and are attached by three hinges. This creates two panels with hinges on the two interior sides of the respective rectangles and two panels, each with one hinge on one interior side. All panels have aligning apertures so that the panels can be collapsed on top of each other to form one rectangle with an aperture through which a screw can be placed and affixed with a wing-nut on the other end, thus keeping the four panels attached. The collapsed set of four panels lie flat with at least one handle on an exterior side to allow for easy storage and transportation.

### TECHNICAL FIELD

The present invention is generally directed to retro-reflective markers. More particularly, the present invention is directed to aircraft landing zone markers. Even more particularly, the present invention is directed to temporary and transportable emergency landing zone markers.

### BACKGROUND OF THE INVENTION

The military, police departments, emergency medical services (EMS) aviation operations, MEDEVAC, and other individuals sometimes require temporary emergency aircraft landing sites. While the present invention may benefit all of the above groups, it is designed as a retro-reflective landing zone marker that is carried in emergency, first responder vehicles and used when needed to transport ill or injured patients or for other similar purposes where an aircraft needs to land.

Emergency medical services (EMS) aviation operations, usually conducted with helicopters, provide an essential service to the public by transporting seriously ill, injured or other patients and individuals to emergency care facilities. This often involves an EMS helicopter transporting a patient from a smaller hospital to a larger critical care facility, but in many instances, the EMS helicopter flies to an accident scene when a patient is not within driving distance of a capable hospital and requires immediate care. Severe automobile accidents, natural disasters, and other emergency situations often arise on flat hard surfaces like highways or in less than desirable locations for helicopter landing and takeoff. In either situation, it is highly desirable that an emergency helicopter landing zone be a large, clear area that is easily seen from a helicopter to protect the EMS team, pilot, and the patient and to facilitate a fast and accurate landing. Finding and designating a nearby area as an appropriate landing zone is often times the responsibility of emergency first responders like members of the local fire department, police force, and/or land EMS team.

The emergency first responders are charged with the task of finding an area of suitably flat land measuring approximately one hundred feet by one hundred feet with no tall obstacles in the way. The area should be as clear of telephone poles, streetlights, and tall trees as possible. In addition, the land surrounding the landing site should be clear of tall obstacles as well. Once this site has been found, first responders properly mark the landing zone for the EMS pilot. Especially at night, or in inclement weather, it can be difficult for an EMS helicopter pilot to spot the landing zone from above. The landing zone may be marked by weighted construction cones, two vehicles with headlights crossed at the center of the landing zone, smoke canisters, battery-operated strobe lights, or Cyalume Chem-lite sticks.

All of the markers listed above have some disadvantages. A useful landing zone marker should be easily transportable, heavy and stable enough to withstand helicopter downdrafts, visible enough to be easily seen from the air in all types of weather and at night, and requiring as little maintenance as possible. Weighted construction cones may be heavy, but, by their very shape, are still at risk of being blown over by the helicopter downdraft and do not provide a large area of reflective material. This is also an issue with other non-weighted markers like Cyalume Chem.-lite sticks and smoke canisters. Furthermore, smoke canisters can only be used during the day in ideal weather conditions. Battery operated strobe lights require maintenance as lights and batteries may need frequent replacing and Chem-lite sticks can only be used once and have a limited shelf life. It is also significant that flashing strobe lights, especially at night, immediately destroy any adaption that is present for the retinas of the pilot. Crossed vehicle head lights may run down vehicle batteries and getting the vehicles in place may not be possible depending upon the environment surrounding the landing zone, and there may not be enough vehicles present.

There is yet another downfall with most of the aforementioned markers. Many EMS helicopter rescue flights occur at night, not just in daylight. As such, it is important that the markers are easily seen from the night sky. The risks associated with pilots not seeing obstacles while flying at night has led to the use of night vision goggles by many EMS Helicopter pilots. Night vision goggles create image enhancement by collecting faint visible light as well as light from the lower portion of the infrared spectrum, which is otherwise undetectable by humans, and amplifying the collected light until images can be detected by humans. When, however, large, visible amounts of light are suddenly found in the night vision goggle field, the amplification can create a temporary washout of the surrounding images. This is seen when a bright moon first appears in the field of vision. It leads to essentially a momentary blindness for the pilot who must adjust to the new source of light. When EMS helicopter pilots are searching for the landing zone, the field of vision can become momentarily washed out by the light from vehicle headlights, battery operated strobes or other strong sources of light. Understandably, this can be dangerous for EMS helicopter pilots and their crew.

The pressure to safely and quickly conduct these missions in difficult environmental conditions including inclement weather, at night, and unfamiliar or poorly marked landing sites make EMS operations inherently dangerous. These hazards result in an increasing number of accidents, and many involve controlled flight into terrain (CFIT) situations, particularly during takeoff and landing. In addition, the number of EMS helicopter accidents that occur during the attempt to find and land at the emergency sight are significant.

Some hospital helipads and airports incorporate reflective materials into their permanent structures as it is a known way to safely mark a landing zone as well as any possible hazards to the helicopter pilot. However, such systems are not to be found at an accident site.

Having a device that first responders can easily transport to emergency situations and use as a safe, highly visible, and relatively immobile landing zone marker could make the landing process much safer for EMS helicopter crews and patients. From the above, it is therefore seen that there exists a need in the art to overcome the deficiencies and limitations described herein and above.

### SUMMARY OF THE INVENTION

The shortcomings of the prior art are overcome and additional advantages are provided through the use of a heavy, flat retro-reflector that can be folded for storage and transportation. When the present invention is unfolded, it withstands downdraft forces as well as strong winds allowing it to be a stable airport landing zone marker. If however, extreme weather conditions or slippery terrain make it prudent to keep the present invention staked to the ground, this can be done through the apertures and/or handles of the invention.

In another aspect, the invention is light enough to be moved to the landing zone by one person. When the invention is folded together and locked in place with a screw through the aligned apertures, it is more easily stored and transported. The folded invention lies flat and can be stacked while stored in first responder vehicles, such as fire trucks and ambulances. Handles on one edge of the folded invention assist in transporting the present invention from storage to the landing zone since many first responders wear thick gloves making it difficult to grasp or hold the reflector without a handle because of its desired heft. The present invention is desirably heavy to withstand downdrafts. Therefore, in preferred embodiments, the handles curve or bend upward, away from the ground or horizontal surface the reflector is resting upon. This leaves enough space for a gloved hand to reach under the handle to grasp it. The tab disposed adjacent to one of the handles reaches from one panel to behind a second panel. The two panels that are in contact with the tab are the two panels that are only attached to one other panel by a single hinge. Since these two panels are only attached to one other panel, they have greater flexibility. The tab ensures that one of the panels doesn't accidentally tilt backwards making it more difficult to unfold.

In another aspect, the invention is designed with retro-reflective materials affixed to the panels. This offers several advantages over other emergency helicopter landing zone markers. It allows for a highly visible marker in all weather conditions, in darkness, and through night vision goggles without the risk of temporary washout or blindness.

Accordingly, it is an object of the present invention to provide a transportable, yet stable, emergency helicopter landing zone that acts as a highly visible marker regardless of weather conditions or time of day.

It is another object of the present invention to provide a landing zone marker which is sufficiently heavy to be immovable in the presence of a helicopter's downdraft.

It is yet another object of the present invention to provide a landing zone marker which is conveniently foldable and on foldable by a single person.

It is a still further object of the present invention to provide a landing zone marker which can be folded and stored easily in and emergency services vehicle.

It is still another object of the present invention to provide a landing zone marker which is easily liftable by a single person.

It is also an object of the present invention provide a landing zone marker which can be secured by a fastener when in its folded position.

It is a still further object of the present invention to provide a landing zone marker assembly comprising four sets of four panels, which can be easily disposed on a substantially flat area to provide demarcation for an emergency helicopter landing zone.

Lastly, but not limited hereto, it is an even further object of the present invention to provide a landing zone marker comprising a material which is both heavy and capable of receiving decal like retro-reflective material.

Additional features and advantages are realized through the techniques of the present invention. Other embodiments and aspects of the invention are described in detail herein and are considered a part of the claimed invention.

The recitation herein of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The subject matter, which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 is a top plan view of one set of four panels displayed in its functional, unfolded state;

FIG. 2 is a side elevational view of the present invention shown in its unfolded configuration;

FIG. 3 is a side elevation view of the present invention shown in its folded state;

FIG. 4 is a top plan view of the present invention illustrating four sets of four panels disposed at the four corners of a desired landing zone; and

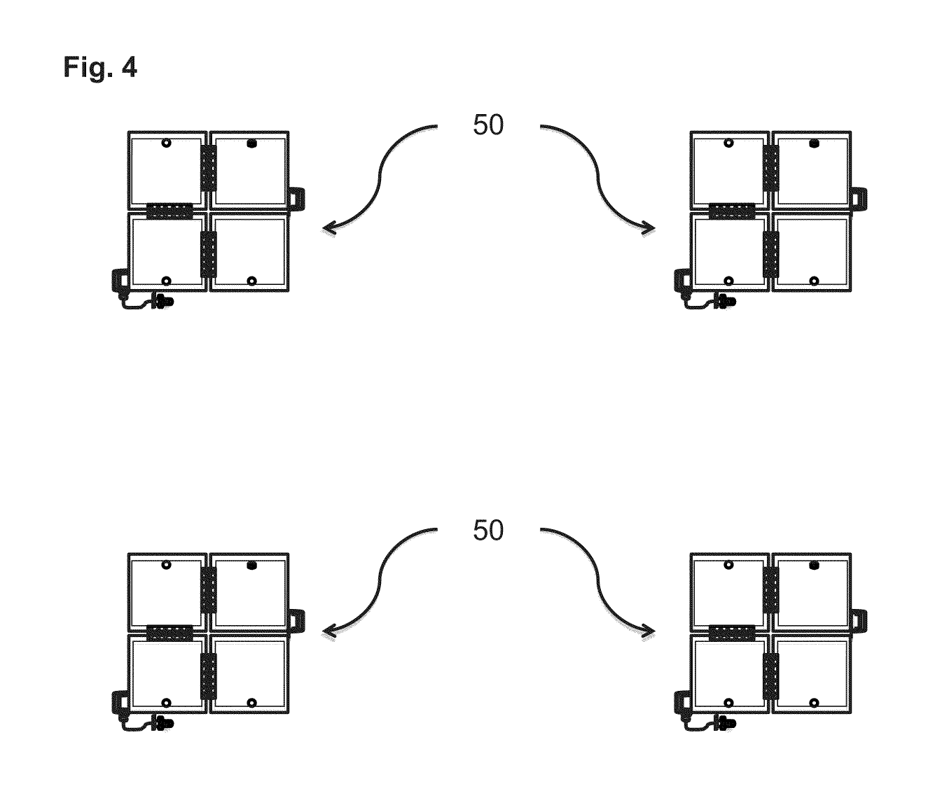

FIG. 5 is a view similar to FIG. 1 except that it illustrates a particular panel coloration.

### DETAILED DESCRIPTION

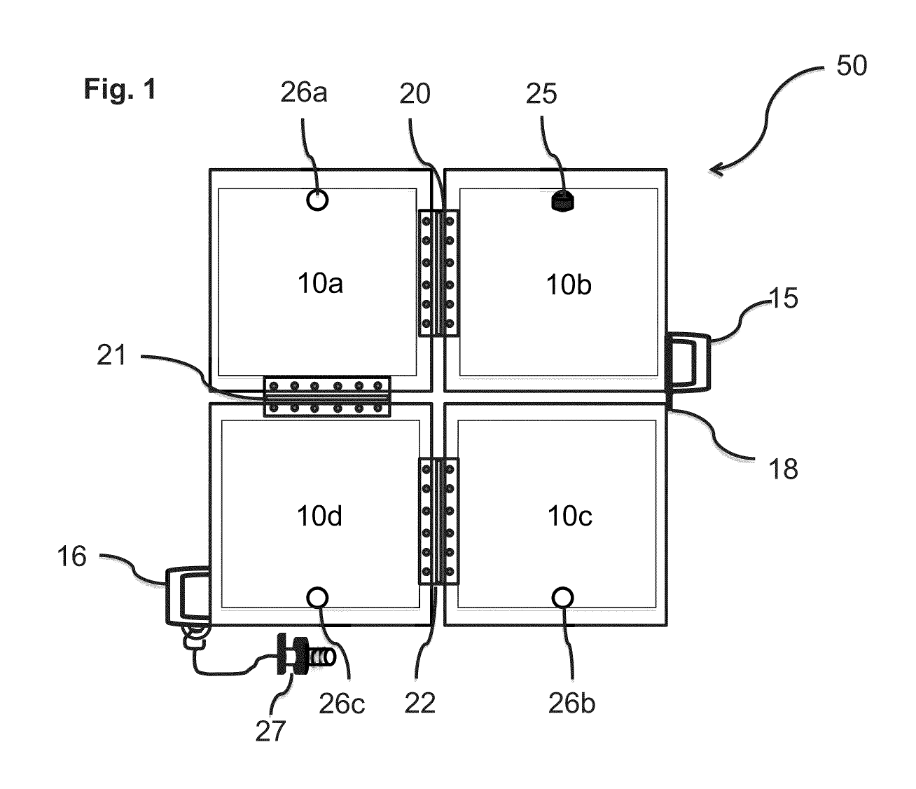

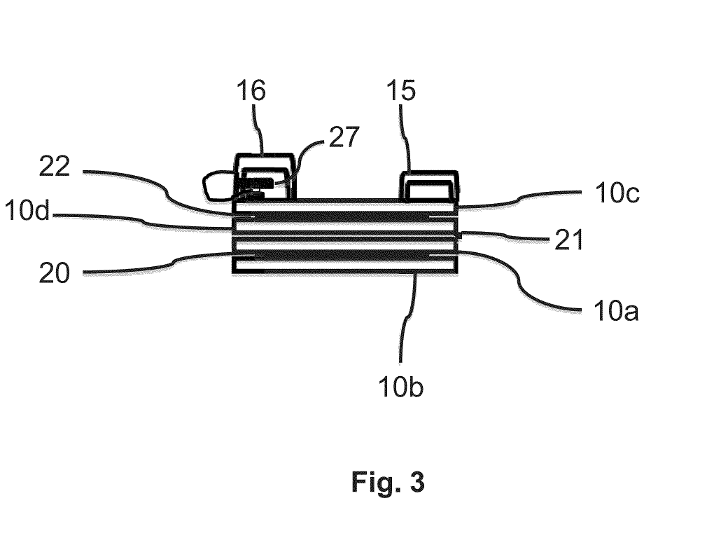

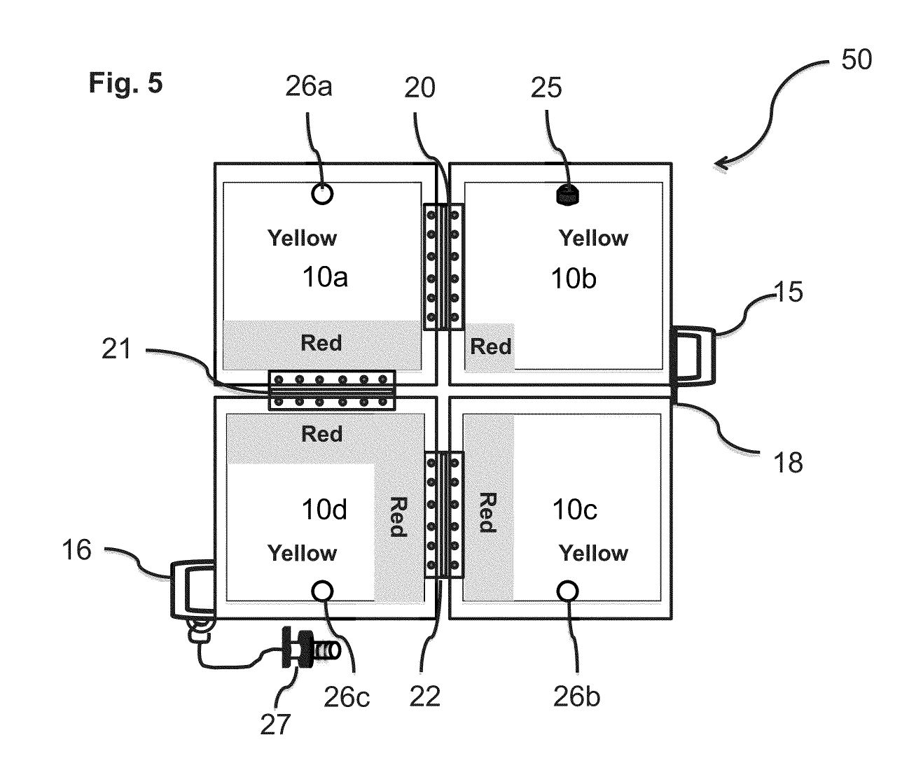

With reference to the drawings, FIGS. 1-3 depict the preferred embodiment of the present invention comprising a set of four panels attached by three hinges and substantially covered on the top side with a retro-reflective material. The four panels (10a, 10b, 10c, and 10d) are flat rectangular pieces of metal. In the preferred embodiment, the panels are square 10 gauge steel plates measuring approximately 15 inches by 15 inches by 0.15 inches thick. The panels are provided with any desired coloration pattern. However, FIG. 5 illustrates a preferred coloration with patterns of red and yellow reflective materials being employed. The pattern shown has the advantage that, when deployed in a set of four “quad-panels” they are positionable so as to define the corners of a square or rectangular landing zone.

The top plan view of each panel (10a, 10b, 10c, and 10d) shows a slightly smaller, similar shaped square within each panel. These each represent retro-reflective material. While any retro-reflective material could be attached to the top of the panels, the preferred embodiment employs 3M™ Diamond Crrade™ reflective material. This reflective, durable, micro prismatic 3M™ sheeting is designed to be highly visible in all light and weather conditions.

Each of the four panels is preferably attached to at least one other panel by a stainless steel hinge (20, 21, and 22) welded to the panel on one side. However, any other convenient means of attachment may be employed such as the use of adhesives, bolts, screws, or rivets. Two panels (10b and 10c), attached to only one hinge, swing forward onto the other two panels (10a and 10d). Panel 10b folds onto 10a and 10c folds onto 10d. The third hinge (21) folds downward so that the bottom sides of 10a and 10d are in contact.

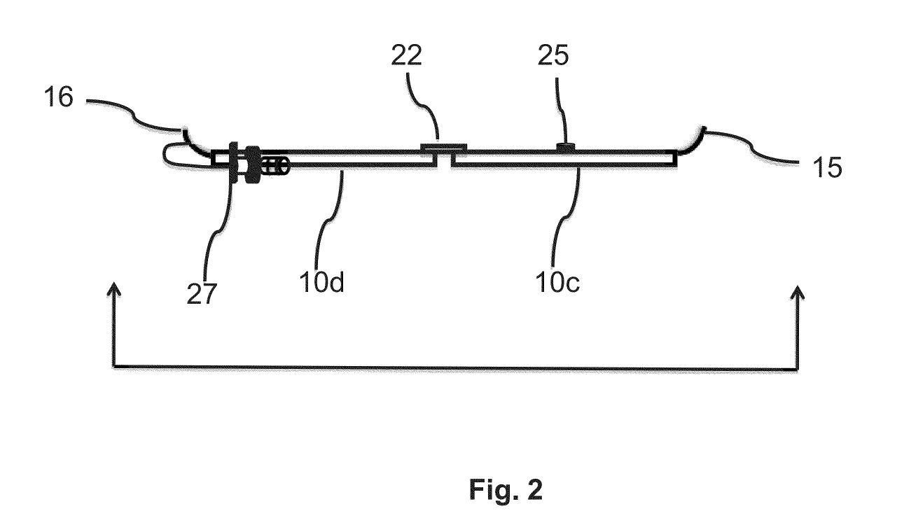

The use of at least one handle is desired, as discussed above. However, in preferred embodiments, there are two handles employed (15 and 16) which are disposed at the exterior edges of two oppositely disposed panels (10b and 10d). When the present invention is in its folded and locked state, both handles protrude from one side of the folded device. The handles embody any convenient shape and may be comprised of any material suitable for carrying the weight of the panels. However, in preferred embodiments of the present invention steel handles are employed which curve upwardly to allow for space between the ground and the handle as seen in FIG. 2. Tab 18 is disposed adjacent to handle 15 on panel 10b, one of the two panels, which are attached to only one other panel by one hinge. Tab 18 extends from an edge of panel 10b to behind panel 10c, the other panel, which is connected to only one other panel by a hinge.

Screw 27, three apertures 26a, 26b, and 26c, and an attached screw receptacle 25 comprise an optional locking mechanism for the present invention in its folded state. The receptacle is located on the top of one of the panels (10b) and aligns with the three apertures, 26a, 26b, and 26c, in panels 10a, 10c, and 10d respectively when the invention is folded. Screw (27), with an enlarged head, is inserted through the three apertures and screwed into the receptacle. This locks the four panels together for storage. In the preferred embodiment, Screw 27 is tethered to handle 16. Those skilled in the art will recognize that other fastening devices may be employed including clevis pins, nuts and bolts, wire, cord, rope, or any similar mechanism.

While the invention has been described in detail herein in accordance with certain preferred embodiments thereof, many modifications and changes therein may be effected by those skilled in the art. Accordingly, it is intended by the appended claims to cover all such modifications and changes as fall within the spirit and scope of the invention.

What is claimed is:

1. An emergency reflector comprising:
a set of four substantially rectangular reflective panels foldable into a similar rectangular form with three adjoining sections being hinged together.

2. The reflector of claim 1 in which said panels are together of sufficient weight to be substantially immobile to aircraft downdrafts.

3. The reflector of claim 1 in which a reflective material is applied to one side of said panels.

4. The reflector of claim 1 in which at least one of said panels has a handle extending from an exterior edge.

6. A plurality of apertures in each of said panels located so as to be aligned in a folded position.

7. The reflector of claim 1 weighing about 35 pounds.

8. The reflector of claim 1 in which each of said panels measures approximately 15 inches by 15 inches by 0.15 inches.

10. The reflector of claim 1 further including a tab disposed at an edge of one of said panels which has only one hinge.

11. The reflector of claim 6 further including a closing fastener comprising a screw and screw receptacle threaded through aligned apertures of a folded reflector.

12. A reflector assembly comprising a set of four reflectors from claim 1 separately disposable at corners of a desired landing zone.

13. A reflector assembly comprising a set of four reflectors from claim 1 separately disposed at four corners of a desired landing zone
